(19) United States
(12) Patent Application Publication
(10) Pub. No.: US 2026/0280439 A1
(43) Pub. Date: Sep. 17, 2026

(54) POWER CONVERTER

(71) Applicant: Infineon Technologies Austria AG, Villach (AT)

(72) Inventors: Daifei ZHANG, Zurich (CH); Johann Walter KOLAR, Zurich (CH); Matthias Joachim KASPER, Villach (AT); Gerald Josef DEBOY, Klagenfurt (AT)

(21) Appl. No.: 19/080,234

(22) Filed: Mar. 14, 2025

(51) Int. Cl. H02M 5/293; H02M 1/00; H02M 7/217

(52) U.S. Cl. CPC H02M 5/2932; H02M 1/0043; H02M 7/217

(57) ABSTRACT

A power converter comprises a switching stage comprising a first switch block configured to connect a first phase input line to one of a first phase output line, a second phase output line, or a third phase output line, a second switch block configured to connect a second phase input line to one of the phase output lines, and a third switch block configured to connect a third phase input line to one of the phase output lines, a three-phase isolation transformer connected to the first phase output line, the second phase output line, and the third phase output line, an output stage connected to the three-phase isolation transformer, and a control engine configured control switching of one of the first switch block, the second switch block, or the third switch block associated with the phase input line having a highest voltage amplitude.

### TECHNICAL FIELD

The present disclosure relates to the field of regulated power conversion.

### BACKGROUND

Various types of devices may utilize electric power converters that convert one form of electric energy to another, such as by changing a voltage of the electric energy or by converting from an alternating current (AC) voltage to a direct current (DC) voltage.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

According to some embodiments, a power converter comprises a switching stage comprising a first switch block configured to connect a first phase input line to one of a first phase output line, a second phase output line, or a third phase output line, a second switch block configured to connect a second phase input line to one of the first phase output line, the second phase output line, or the third phase output line, and a third switch block configured to connect a third phase input line to one of the first phase output line, the second phase output line, or the third phase output line, a three-phase isolation transformer comprising a first primary winding connected to the first phase output line, a second primary winding connected to the second phase output line, and a third primary winding connected to the third phase output line, an output stage connected to the three-phase isolation transformer, and a control engine configured to generate an output signal at the output stage by controlling switching of one of the first switch block, the second switch block, or the third switch block associated with one of the first phase input line, the second phase input line, or the third phase input line having a highest voltage amplitude.

According to some embodiments, a power converter comprises a matrix front end comprising a first switching leg connected to a high side terminal, a low side terminal, and a first phase input line, a second switching leg connected to the high side terminal, the low side terminal, and a second phase input line, and a third switching leg connected to the high side terminal, the low side terminal, and a third phase input line, an integrated active filter connected to the high side terminal and the low side terminal, comprising an injection inductor selectively connected to one of the first phase input line, the second phase input line, or the third phase input line, and a fourth switching leg connected to the high side terminal, the low side terminal, and the injection inductor, an isolation circuit connected to the high side terminal and the low side terminal, an output stage connected to the isolation circuit, and a control engine configured to generate an output signal at the output stage by controlling switching of a first selected switching leg of the first switching leg, the second switching leg, or the third switching leg according to a first duty cycle, controlling switching of a second selected switching leg of the first switching leg, the second switching leg, or the third switching leg according to a complement of the first duty cycle, connecting one of the first phase input line, the second phase input line, or the third phase input line not associated with the first selected switching leg or the second selected switching leg to the injection inductor, and controlling switching of the fourth switching leg according to a second duty cycle.

According to some embodiments, a method comprises connecting a first switching leg to a high side terminal, a low side terminal, and a first phase input line, connecting a second switching leg to the high side terminal, the low side terminal, and a second phase input line, connecting a third switching leg to the high side terminal, the low side terminal, and a third phase input line, selectively connecting an injection inductor to one of the first phase input line, the second phase input line, or the third phase input line, connecting a fourth switching leg to the high side terminal, the low side terminal, and the injection inductor, connecting an isolation circuit to the high side terminal and the low side terminal, connecting an output stage to the isolation circuit, and generating an output signal at the output stage by controlling switching of a first selected switching leg of the first switching leg, the second switching leg, or the third switching leg according to a first duty cycle, controlling switching of a second selected switching leg of the first switching leg, the second switching leg, or the third switching leg according to a complement of the first duty cycle, connecting one of the first phase input line, the second phase input line, or the third phase input line not associated with the first selected switching leg or the second selected switching leg to the injection inductor, and controlling switching of the fourth switching leg according to a second duty cycle.

According to some embodiments, a system comprises means for connecting a first switching leg to a high side terminal, a low side terminal, and a first phase input line, means for connecting a second switching leg to the high side terminal, the low side terminal, and a second phase input line, means for connecting a third switching leg to the high side terminal, the low side terminal, and a third phase input line, means for selectively connecting an injection inductor to one of the first phase input line, the second phase input line, or the third phase input line, means for connecting a fourth switching leg to the high side terminal, the low side terminal, and the injection inductor, means for connecting an isolation circuit to the high side terminal and the low side terminal, means for connecting an output stage to the isolation circuit, and means for generating an output signal at the output stage by controlling switching of a first selected switching leg of the first switching leg, the second switching leg, or the third switching leg according to a first duty cycle, controlling switching of a second selected switching leg of the first switching leg, the second switching leg, or the third switching leg according to a complement of the first duty cycle, connecting one of the first phase input line, the second phase input line, or the third phase input line not associated with the first selected switching leg or the second selected switching leg to the injection inductor, and controlling switching of the fourth switching leg according to a second duty cycle.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 illustrates a diagram of a power converter, in accordance with some embodiments.

FIGS. 2A and 2B illustrate waveform diagrams for controlling a power converter, in accordance with some embodiments.

FIG. 3 illustrates a control diagram for controlling a power converter, in accordance with some embodiments.

FIG. 4 illustrates a diagram of a power converter, in accordance with some embodiments.

FIG. 5A illustrates a vector space diagram for three-phase matrix switching, in accordance with some embodiments.

FIG. 5B illustrates a timing diagram for switching in a power converter, in accordance with some embodiments.

FIG. 5C illustrates a waveform diagram for operation of a power converter, in accordance with some embodiments.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

It is to be understood that the following description of embodiments is not to be taken in a limiting sense. The scope of the present disclosure is not intended to be limited by the embodiments described hereinafter or by the drawings, which are taken to be illustrative only. The drawings are to be regarded as being schematic representations and elements illustrated in the drawings are not necessarily shown to scale. Rather, the various elements are represented such that their function and general purpose become apparent to a person skilled in the art.

All numerical values within the detailed description and the claims herein are modified by “about” or “approximately” the indicated value, and take into account experimental error and variations that would be expected by a person having ordinary skill in the art.

The term “power converter apparatus” and/or the like as used herein broadly refers to any type of power converter or voltage regulator (VR) that provides one or more regulated voltages to one or more electronic loads such as an Ethernet switch, an Ethernet router, an application-specification integrated circuit (ASIC), a memory device, a processor such as a central processing unit (CPU), a microprocessor, a graphics processing unit (GPU), a digital signal processor (DSP), an artificial intelligence (AI) accelerator, an image processor, a network or packet processor, a coprocessor, a multi-core processor, a front-end processor, a baseband processor, a field programmable gate array (FPGA), a lighting element, a power tool, a vehicle, a motor, or some other suitable load.

The term “power converter apparatus” and/or the like as used herein means a functional assembly, such as a packaged functional assembly or a combination of one or more printed circuit boards and/or discrete components, that includes a regulated power converter including a switching circuit used in converting a voltage from one level to another level, e.g., as in power conversion, power factor correction, and voltage regulation. The power converter apparatus may also include a driver circuit for driving the switching circuit. The power converter apparatus may additionally include a control engine for controlling the driver circuit so as to implement the power converter. The control engine may be configured to control the regulated power converter to reduce a voltage error of the output voltage, such as a difference between the output voltage and a target voltage, to control a current error of the output current, such as a difference between the output current and a target current, to provide power factor correction, or some other power conversion function.

The power converter apparatus supplies power, to a DC load, such as a battery, a supercapacitor, or some other DC load, at an output of the power converter apparatus in a grid connected embodiment (i.e., AC/DC conversion). The control engine and/or driver functionality may instead be implemented outside the power converter apparatus. Driver circuits for switching circuits in the power converter apparatus also may be outside the power converter apparatus. Various passive components such as capacitors and/or inductors may be included in the power converter apparatus, surface mounted to the power converter apparatus, located on a separate board, etc.

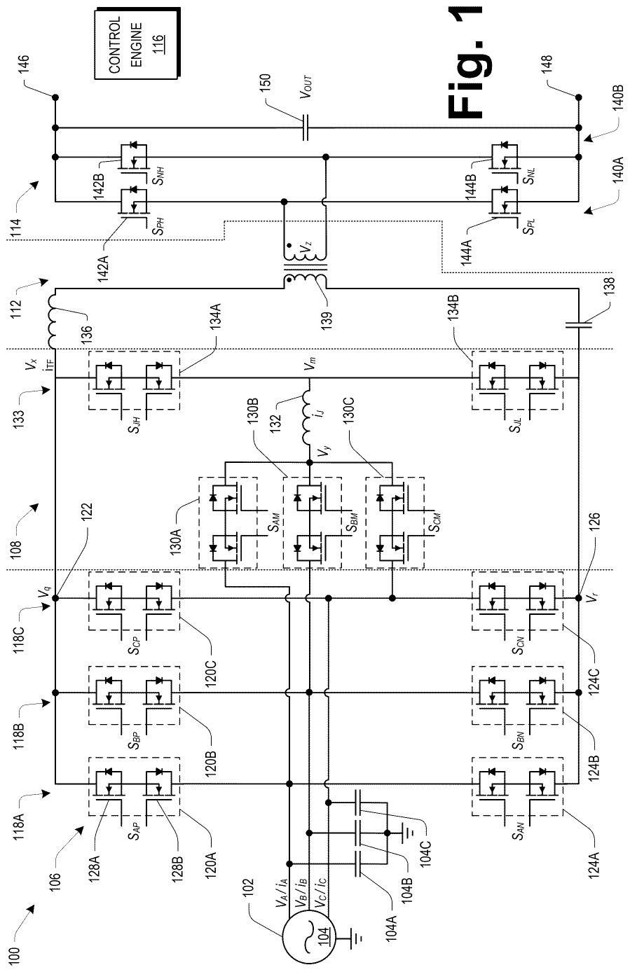

Referring to FIG. 1 a diagram of a power converter 100 is provided, in accordance with some embodiments. The power converter 100 is connected to a power supply 102 and comprises filter capacitors 104A, 104B, 104C connected to the power supply 102, a matrix front end 106 connected to the filter capacitors 104A, 104B, 104C, an integrated active filter (IAF) 108, connected to the matrix front end 106, an isolation circuit 112 connected to the IAF 108, an output stage 114 connected to the isolation circuit 112, and a control engine 116 configured to generate control signals for controlling the power converter 100 and the output stage 114 to power a load. The load may be a battery, a supercapacitor, or some other DC load. The power supply 102 is illustrated as a three-phase AC supply with A, B, and C phase input lines providing phase voltages V_{A}, V_{B}, and V_{C} and phase currents i_{A}, i_{B}, and i_{C}.

In some embodiments, the power converter 100 controls and/or regulates an output voltage and/or an output current for the load. The power converter 100 may control the output voltage at the output to match a target voltage and/or the power converter 100 may be configured to reduce a voltage error of the output voltage. The voltage error may correspond to a difference between the output voltage and the target voltage. In a current control mode, the power converter 100 may control the output current provided to the load based on a target current or a maximum current. In some embodiments, the power converter 100 may switch between voltage control modes and current control modes.

In some embodiments, the matrix front end 106 comprises three switching legs 118A, 118B, 118C connected to the power supply 102. Each switching leg 118A, 118B, 118C comprises positive bidirectional switches 120A, 120B, 120C controlled by switching signals S_{AP}, S_{BP}, S_{CP} connected to a high side terminal 124 of the matrix front end 106 and negative bidirectional switches 124A, 124B, 124C controlled by switching signals S_{AN}, S_{BN}, S_{CN} connected to a low side terminal 126 of the matrix front end 106. In some embodiments, each of the positive bidirectional switches 120A, 120B, 120C and the negative bidirectional switches 124A, 124B, 124C are implemented using a pair of transistors 128A, 128B (illustrated for the positive bidirectional switch 120A) with body diodes facing in opposite directions such that conduction occurs in both directions in an “ON” state and blocking is provided in both directions in an “OFF” state. Other structures and/or configurations of the positive bidirectional switches 120A, 120B, 120C and the negative bidirectional switches 124A, 124B, 124C are within the scope of the present disclosure.

In some embodiments, the IAF 108 comprises bidirectional switches 130A, 130B, 130C S_{AM}, S_{BM}, S_{CM} and connected between the switching legs 118A, 118B, 118C, respectively, and an injection inductor 132 having an inductance of L_{INJ}. An injection switching leg 133 comprises bidirectional switches 134A, 134B controlled by S_{JH}, S_{JL} and connected between the high side terminal 122 and the injection inductor 132 and between the low side terminal 126 and the injection inductor 132, respectively. Other structures and/or configurations of the IAF 108 are within the scope of the present disclosure.

In some embodiments, the isolation circuit 112 comprises an inductor 136 connected to the high side terminal 122, a blocking capacitor 138 connected to the low side terminal 126, and a galvanic isolation transformer 139. The inductor 136 may represent the leakage inductance of the galvanic isolation transformer 139 or an additional inductor may be provided in the isolation circuit 112.

In some embodiments, the output stage 114 uses a dual active bridge (DAB) topology with two rectifier legs 140A, 140B, each comprising high side switches 142A, 144A connected to a high side node 146 and low side switches 142B, 144C connected to a low side node 148, respectively. An output capacitor 150 is connected across the high side node 146 and the low side node 148 to generate the output voltage (V_{OUT}) for powering the load. Other structures and/or configurations of the output stage 114 are within the scope of the present disclosure.

In some embodiments, the control engine 116 controls the switching of the matrix front end 106, the IAF 108, and the output stage 114 to generate the output voltage (V_{OUT}).

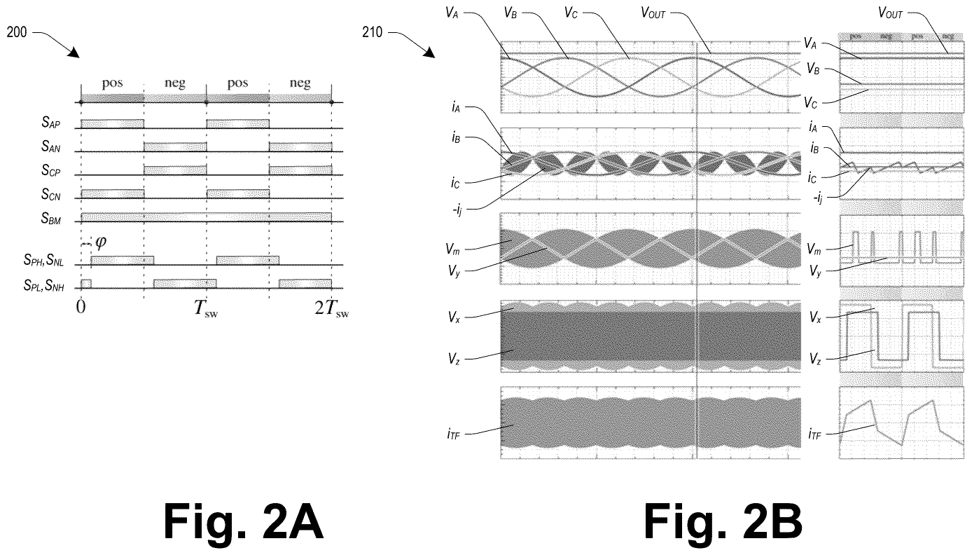

FIGS. 2A and 2B illustrate waveform diagrams 200, 210 for controlling the power converter 100, in accordance with some embodiments. As illustrated in FIG. 2A, in the matrix front end 106, only the switching legs 118A, 118C associated with the phases forming the highest line-to-line voltage (i.e., in the illustrated case, phases A and C for a given portion of a mains cycle) are switched with complementary duty cycles to generate drive current, and the switching leg 118B (S_{BP} and S_{BN}) remains in the OFF state. The IAF 108 is controlled to generate injection current using the phase input line with the middle voltage amplitude. Generating the switching signals S_{AP}/S_{CN} and/or S_{AN}/S_{CP} allows the generating of a drive current that results in a high-frequency AC voltage Vₓ at the isolation circuit 112 with an amplitude defined by the line-to-line voltage V_{AC}. Accordingly, the amplitude of Vₓ and the transformer current (i_{TF}) entering exhibit a six-pulse shape over one mains period.

For other portions of the mains cycle, the phase input lines with the maximum and minimum voltages are switched using the switching legs 118A, 118B, 118C to generate drive current and the phase input line with the middle voltage amplitude is switched using the IAF 108 to generate injection current.

The output stage 114 is controlled at a frequency corresponding to the switching frequency (f_{SW}) of the matrix front end 106 to control the current flow, power flow, or output voltage by adjusting the phase shift (φ) between Vₓ and V_{z} and/or by applying the voltage difference, Vₓ−V_{z}, over the stray inductance of the galvanic isolation transformer 139.

Assuming an instantaneously constant power flow regulated by the output stage 114, which is required to provide a constant voltage at a given load, 3-φ sinusoidal mains currents can be achieved by utilizing the IAF 108. The IAF 108 injects a current into phase B, otherwise phase B would remain with no current, as the bidirectional switches 120B, 124B remain in the OFF state based on the control signals, S_{BP}, S_{BN} being at an OFF logic state. The IAF 108 generates the injection current by asserting S_{BM} and de-asserting S_{AM} and S_{CM} and controlling the current (i) through the injection inductor 132 by gating S_{JH} and S_{JL} to shape the injection inductor current (i) into a section of a sinusoidal waveform. The injection inductor current (i) aligns with the mains current i_{b}, which is required to draw a constant power delivered to the DC output from the mains, in combination with sinusoidal currents in phases A and C. This concept is known as 3rd-harmonic current injection. The switching state of the injection leg controlled by S_{JH} and S_{JL} is reversed in a complementary manner any time Vₓ changes polarity.

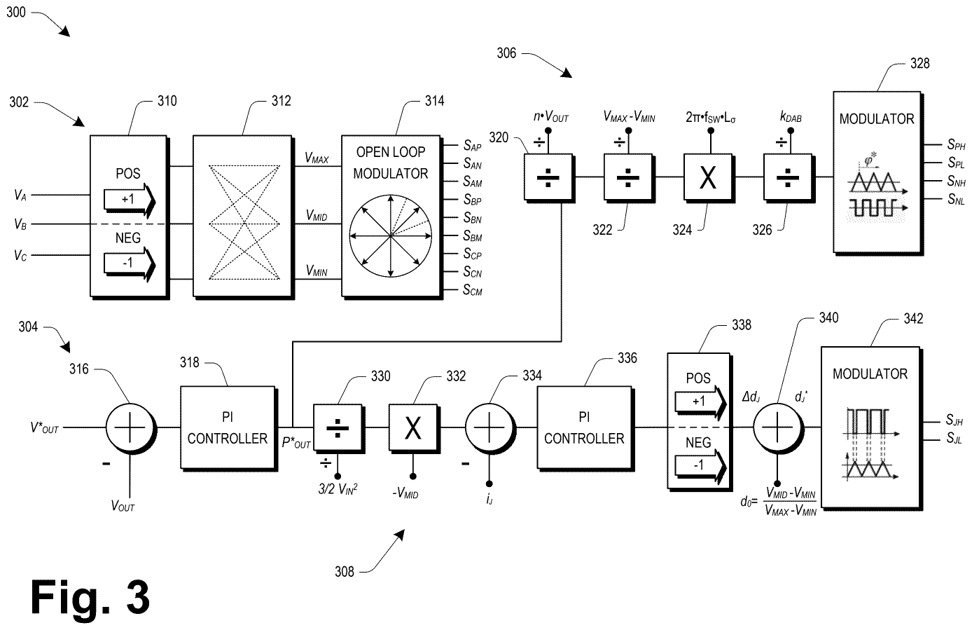

FIG. 3 illustrates a control diagram 300 for controlling the power converter 100, in accordance with some embodiments. The control engine 116 implements the functionality illustrated in the control diagram 300 to provide 3-φ sinusoidal mains currents and constant power transferred through the galvanic isolation to the load. The control diagram 300 comprises a matrix front end control block 302, an output voltage control block 304, an output stage modulation block 306, and a current injection control block 308.

In some embodiments, the matrix front end control block 302 converts 3-φ low frequency (e.g., 50 Hz mains frequency) voltages Vₐ, V_{b}, and V_{C} into a high frequency switched voltage Vₓ using an open-loop approach (i.e., without feedback regulation) based on the measured 3-φ mains voltages. One switching period is equally divided into a positive half cycle and a negative half cycle. A sign block 310 generates a half cycle indicator and a comparator block 312 generates a maximum transformer winding voltage (V_{MAX}), a middle transformer winding voltage (V_{MID}), and a minimum transformer winding voltage (V_{MIN}). An open loop modulator 314 generates the switching signals (S_{AP}, S_{AN}, S_{AM}, S_{BP}, S_{BN}, S_{BM}, S_{CP}, S_{CN}, S_{CM}) such that during the positive half cycle, a potential (V_{q}) at the high side terminal 122 is connected to the phase with the maximum (positive) voltage by turning on the corresponding positive bidirectional switches 120A, 120B, 120B and a potential (Vr) at the low side terminal 126 is connected to the phase with the minimum voltage by turning on the corresponding bidirectional switches 124A, 124B, 124C. This arrangement is reversed during the negative half-cycle. For instance, considering a 60° mains interval where V_{A}>V_{B}>V_{C}: during the positive half cycle, V_{A}>V_{B}>V_{C} V_{q}=V_{A} and Vᵣ=V_{C}; and during the negative half cycle, V_{q}=V_{C} and Vᵣ=V_{A}. Furthermore, the corresponding bidirectional switches 130A, 130B, 130C connect the phase with the middle voltage amplitude to the injection inductor 132.

In some embodiments, the output voltage control block 304 comprises an addition unit 316 that determines an error between a reference output voltage (V*_{OUT}) and the output voltage (V_{OUT}) to generate an error signal for a proportional-integral (PI) controller 318. The PI controller 318 generates a power reference (P*_{OUT}).

In some embodiments, the output stage modulation block 306 regulates the output stage 114 to deliver the required output power using basic phase shift modulation. The power transferred across the galvanic isolation transformer 140 depends linearly on the transformer winding voltages (V_{MAX}, V_{MID}, and V_{MIN}), where Vₓ=V_{MAX}−V_{MIN} and V_{z}=V_{OUT}, and the phase shift between V_{X} and V_{Z} is:

$${P}_{OUT}^{*} = \frac{n \cdot {V}_{OUT} \cdot ( {V}_{MAX} - {V}_{MIN} )}{2 π \cdot {f}_{SW} \cdot {L}_{σ}} \cdot \frac{{φ}^{*} \cdot ( π - \vert {φ}^{*} \vert )}{π} = \frac{n \cdot {V}_{OUT} \cdot ( {V}_{MAX} - {V}_{MIN} )}{2 π \cdot {f}_{SW} \cdot {L}_{σ}} \cdot {k}_{DAB} \cdot {φ}^{*} ,$$

where n is turns ratio of the galvanic isolation transformer 139, and L_{σ} is the leakage inductance of the galvanic isolation transformer 139. Note that V_{MAX}−V_{MIN} follows a six-pulse shaped waveform over one mains period, and therefore, φ* exhibits an inverse six-pulse shape (not constant) in steady-state operation to deliver a constant output power

$$( {P}_{OUT}^{*} ) .$$

In some embodiments, output stage modulation block 306 solves for the phase shift φ* by dividing the power reference (P*_{OUT}) from the PI controller 318 by n·V_{OUT} in a divider 320, dividing by V_{MAX}−V_{MIN} in a divider 322, multiplying by 2π·f_{SW}·L_{σ} in a multiplier 324, dividing by k_{DAB} in a divider 326. The phase shift φ* is received by a modulator 328 that applies the phase shift to the signal provided to control the output stage 114.

In some embodiments, the current injection control block 308 controls the IAF 108 using 3^{rd} harmonic current injection. The input conductance of the IAF 108 (G*) is derived from the power reference (P*_{OUT}), assuming that the current references of the 3-φ sinusoidal mains are proportional to the corresponding measured 3-φ input phase voltages V_{A}, V_{B}, and V_{C}, ensuring purely ohmic operation of the 3-φ mains. Thus, the injection current (iⱼ) equals the phase current with the minimum amplitude, i.e., the current in the phase with the minimum phase voltage amplitude,

$${i}_{j}^{*} = {G}^{*} \cdot {V}_{MID} .$$

The injection current (iⱼ) is regulated by comparing its reference (iⱼ*) with the measured value of iⱼ. The current injection control block 308 divides the power reference (P*_{OUT}) from the PI controller 318 by

$$\frac{3}{2} \cdot {\hat{V}}_{IN}^{2}$$

(i.e., the three-phase mains voltage amplitude) in a divider 330, divides the result from the divider 330 by −V_{MID} in a divider 332 to generate the current reference

$$( {i}_{j}^{*} ) .$$

An addition unit 334 subtracts the measured value of iⱼ from the current reference

$$( {i}_{j}^{*} )$$

to generate an injection current error signal. A PI controller 336 receives the injection current error signal and generates a duty cycle correction (Δdⱼ). The output of the PI controller 336 is provided to a sign unit 338 that determines the sign of the duty cycle correction (Δdⱼ) as a positive value during the positive half cycle and a negative value during the negative half cycle. An addition unit 340 adds the duty cycle correction (Δdⱼ) adjusted by the sign unit 338 to a feedforward duty cycle (d₀) to generate the corrected duty cycle

$$( {d}_{j}^{*} ) .$$

To increase the injection current (iⱼ), a positive correction voltage across the injection inductor 132 is imposed by adding the duty cycle correction (Δdⱼ) during the positive half-cycle and subtracting the duty cycle correction (Δdⱼ) during the negative half-cycle based on the output of the sign unit 338. In the positive cycle, a positive correction voltage (Vₘ) at the output of the injection inductor 132 requires a positive duty cycle correction (Δdⱼ) to increase the duty cycle of the bidirectional switch 134A and reduce the duty cycle of the bidirectional switch 134B since V_{q}>0 and Vᵣ<0. Conversely, in the negative half-cycle, a negative duty cycle correction (Δdⱼ) is needed to reduce the turn-on time of the bidirectional switch 134A to achieve a positive correction voltage across the injection inductor 132. At 60° sector boundaries over one mains period, the input voltage (V_{y}) of the injection inductor 132 changes abruptly. The feedforward duty cycle (d₀) improves the dynamic response of the control engine 116 according to:

$${d}_{0} = \frac{{V}_{MID} - {V}_{MIN}}{{V}_{MAX} - {V}_{MIN}} .$$

A modulator 342 is controlled by the corrected duty cycle to generate the switching signals S_{JH}, S_{JL} for the Thus, the IAF 108 is controlled to actively inject a 3rd-harmonic current (iⱼ) into the phase with the minimum instantaneous voltage amplitude, ensuring a sinusoidal shape for the mains phase currents, as well as maintaining constant system input and/or output power.

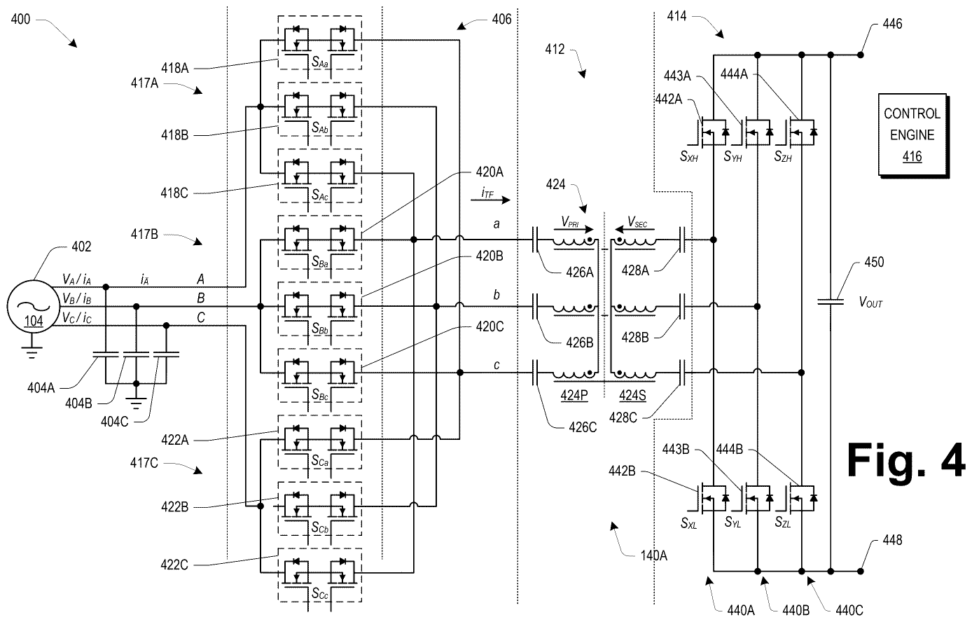

Referring to FIG. 4 a diagram of a power converter 400 is provided, in accordance with some embodiments. The power converter 400 is connected to a power supply 402 and comprises filter capacitors 404A, 404B, 404C connected to the power supply 402, a switching stage 406 connected to the filter capacitors 404A, 404B, 404C, an isolation circuit 412 connected to the switching stage 406, an output stage 414 connected to the isolation circuit 412, and a control engine 416 configured to generate control signals for controlling the power converter 400 to power a load. The load may be a battery, a supercapacitor, or some other DC load. The power supply 402 is illustrated as a three-phase AC supply with A, B, and C phases generating phase voltages V_{A}, V_{B}, and V_{C} and phase currents i_{A}, i_{B}, and i_{C}.

In some embodiments, the switching stage 406 comprises phase A switch block 417A comprising bidirectional switches 418A, 418B, 418C, a phase B switch block 417B comprising bidirectional switches 420A, 420B, 420C, and phase C switch block 417C comprising bidirectional switches 422A, 422B, 422C controlled by switching signals S_{Aa}, S_{Ab}, S_{Ac}, S_{Ba}, S_{Bb}, S_{Bc}, S_{Ca}, S_{Cb}, S_{Cc}, respectively, where the first letter of the switching signal index represents a phase input line (A, B, or C) and the second letter of the switching signal index represents a phase output line (a, b, or c).

In some embodiments, the isolation circuit 412 comprises a three-phase transformer 424, blocking capacitors 426A, 426B, 426C connected to a primary side 424P of the three-phase transformer 424, and blocking capacitors 428A, 428B, 428C connected to a secondary side 424S of the three-phase transformer 424.

In some embodiments, the output stage 414 uses a three-phase dual active bridge (DAB) topology with three rectifier legs 440A, 440B, 440C on the secondary side 424S of the three-phase transformer 424, each comprising high side switches 442A, 443A, 444A connected to a high side node 446 and low side switches 442B, 443B, 444B connected to a low side node 448, respectively, and controlled by switching signals (S_{XH}, S_{XL}, S_{YH}, S_{YL}, S_{ZH}, S_{ZL}). An output capacitor 450 is connected across the high side node 446 and the low side node 448 to generate the output voltage (V_{OUT}) for powering the load. Other structures and/or configurations of the output stage 414 are within the scope of the present disclosure.

In some embodiments, the control engine 416 controls the switching of the switching stage 406 to generate the output voltage (V_{OUT}). In the following example, it is assumed that the power supply provides voltages following the relationship, V_{A}>V_{B}>V_{C}, considering a 60° wide interval of the mains period.

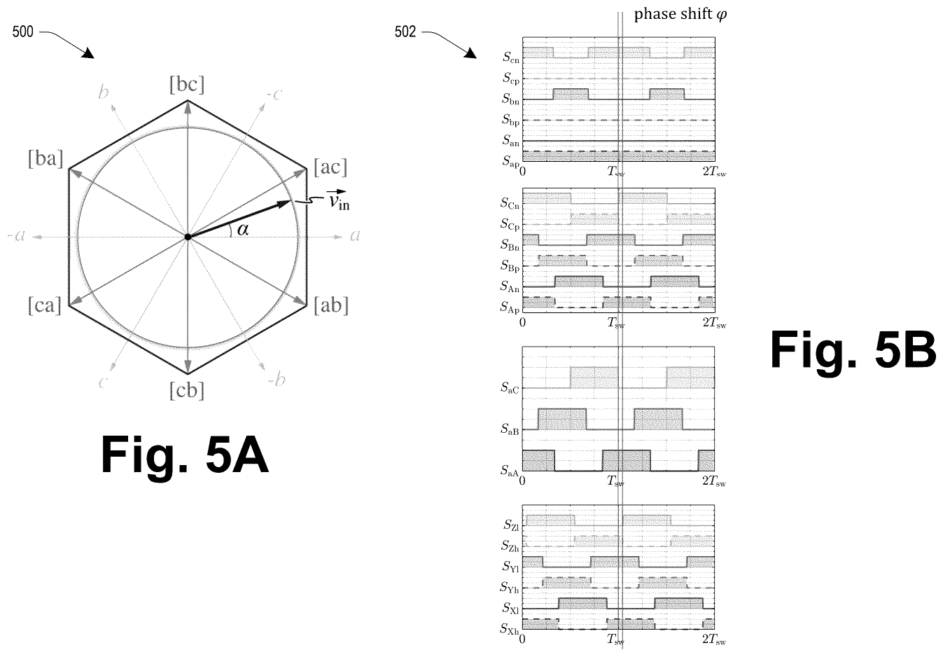

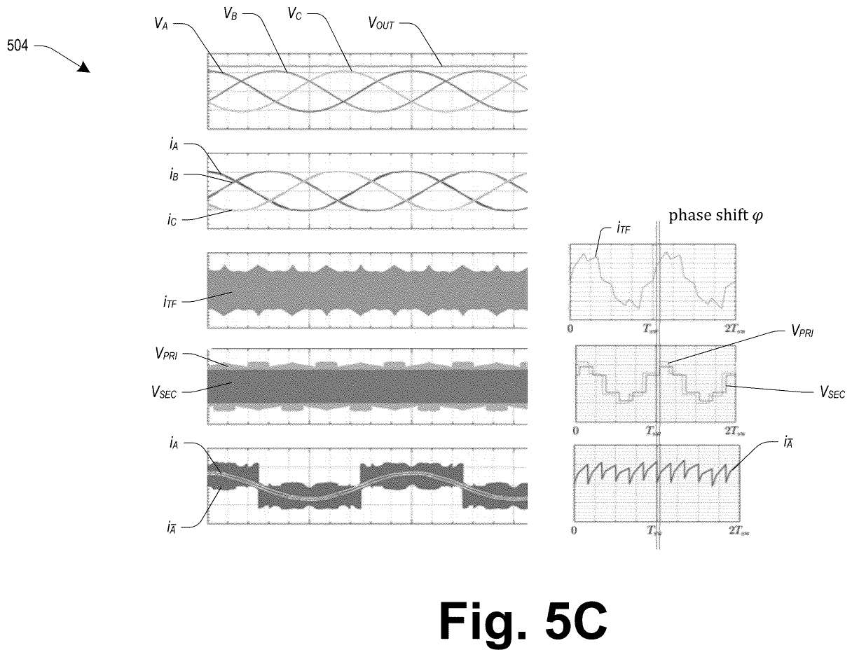

The switching stage 406 integrates the functionality of a three-phase matrix front end (similar to the matrix front end 106 of FIG. 1) and a three-phase DAB in parallel with the matrix front end on the primary side 424P of the three-phase isolation transformer 424. FIG. 5A is a vector space diagram 500 illustrating three-phase matrix switching, in accordance with some embodiments. FIG. 5B is a timing diagram 502 illustrating switching in the power converter 400, in accordance with some embodiments. The mains period is divided into 6, 60° sectors a, −c, b, −a, c, and −b bounded by vertices [ab], [ac], [bc], [ba], [ca], and [cb], respectively. The first letter of a vertex denotes the phase connected to the positive node by the matrix front end and the second letter of the vertex denotes the phase connected to the negative node by the matrix front end. In a given sector, either the positive node values or the negative node values will be the same. For example, for the sector a bounded by vertices [ab]:[ac] and spanning between −30° and 30°, the positive node phases are both a, which represents the phase input line with the highest voltage amplitude. For the common phase output line (phase input line A), the S_{AP} signal is held at an “ON” logic state during the sector and the S_{AN} signal is held at an “OFF” logic state to generate injection current. The timing signals for the other phases for the sector (S_{BP}, S_{BN}, S_{CP}, S_{CN}) are switched based on duty cycles that depend on the angle, a, within the sector to generate drive current according to:

$${d}_{[ ab ]} = \frac{sin ( 30 - α )}{cos ( α )} , {d}_{[ ac ]} = \frac{sin ( 30 + α )}{cos ( α )} ,$$

as illustrated in FIG. 5B. The other sectors use similar switching schemes with different injection and switching output phases. For example, for the sector −c bounded by vertices [ac]:[bc], the S_{CP} signal is held at an “OFF” logic state during the sector and the S_{CN} signal is held at an “ON” logic state since the common phase in in the N position. The timing signals (S_{AP}, S_{AN}, S_{BP}, S_{BN}) for the other phases for the sector are switched according to the angle within the sector −c.

In some embodiments, the three-phase DAB switching signals (S_{Ap}, S_{Ap}, S_{Bp}, S_{Bn}, S_{Cp}, S_{Cn}) employ a 50% duty cycle with a 120° phase shift between phases, as illustrated in FIG. 5B. Similarly, the output stage 414 employs three-phase DAB switching signals with a 50% duty cycle with a 120° phase shift between phases, as illustrated in FIG. 5B. The phase shift (φ) between the primary side and the secondary side DAB signals is determined by the control engine 416 to control power delivered to the load.

The matrix front end signals and DAB signals are virtual constructs to generate the timing signals for the phase A switch block 417A, the phase B switch block 417B, or the phase C switch block 417C according to the active sector. The sector name in FIG. 5A, denotes the active phase, for example, the phase A switch block 417A for sectors a and −a, the phase B switch block 417B for sectors b and −b, and the phase C switch block 417C for sectors c and −c.

As illustrated in FIG. 5B, the matrix front end signals and DAB virtual construct signals for sector a are combined according to:

$${S}_{Aa} = {S}_{ap} \cdot {S}_{Ap} + {S}_{an} * {S}_{An} ,$$

$${S}_{Ab} = {S}_{ap} \cdot {S}_{Bp} + {S}_{an} * {S}_{Bn} , and$$

$${S}_{Ac} = {S}_{ap} \cdot {S}_{Cp} + {S}_{an} * {S}_{Cn}$$

to generate the timing signals for the phase A bidirectional switches 418A, 418B, 418C.

FIG. 5C is a waveform diagram 504 illustrating operation of the power converter 400, in accordance with some embodiments. As illustrated in FIG. 5A, generating the switching signals for the switching stage 406 (S_{Aa}, S_{Ab}, S_{Ac}, S_{Ba}, S_{Bb}, S_{Bc}, S_{Ca}, S_{Cb}, S_{Cc}) and the switching signals for the output stage 414 (S_{Xh}, S_{Xl}, S_{Yh}, S_{Yl}, S_{Zh}, S_{Zl}) allows the generating of a high-frequency AC voltage V_{PRI} with a corresponding current (i_{TF}) at the primary side 424P of the isolation circuit 412 and a voltage V_{SEC} at the secondary side 424S of the isolation circuit 412 with an amplitude defined by the line-to-line voltage V_{AC}. The amplitude of V_{PRI} and the transformer current (i_{TF}) entering exhibit a six-pulse shape over one mains period.

The output stage 114 is controlled at a frequency corresponding to the switching frequency (f_{SW}) of the switching stage 406 to control the current flow, power flow, or output voltage by adjusting the phase shift (φ) between V_{PRI} and V_{SEC}.

According to some embodiments, a power converter comprises a switching stage comprising a first switch block configured to connect a first phase input line to one of a first phase output line, a second phase output line, or a third phase output line, a second switch block configured to connect a second phase input line to one of the first phase output line, the second phase output line, or the third phase output line, and a third switch block configured to connect a third phase input line to one of the first phase output line, the second phase output line, or the third phase output line, a three-phase isolation transformer comprising a first primary winding connected to the first phase output line, a second primary winding connected to the second phase output line, and a third primary winding connected to the third phase output line, an output stage connected to the three-phase isolation transformer, and a control engine configured to generate an output signal at the output stage by controlling switching of one of the first switch block, the second switch block, or the third switch block associated with one of the first phase input line, the second phase input line, or the third phase input line having a highest voltage amplitude.

According to some embodiments, the switching stage comprises a first bidirectional switch connected to the first phase input line, a second bidirectional switch connected to the second phase input line, and a third bidirectional switch connected to the third phase input line, wherein the control engine is configured to control switching of the switching stage by controlling switching of the first bidirectional switch, the second bidirectional switch, and the third bidirectional switch.

According to some embodiments, the power converter comprises a first blocking capacitor connected between the first phase output line and the first primary winding, a second blocking capacitor connected between the second phase output line and the second primary winding, and a third blocking capacitor connected between the third phase output line and the third primary winding.

According to some embodiments, the three phase isolation transformer comprises a first secondary winding connected to the first phase output line, a second secondary winding connected to the second phase output line, and a third secondary winding connected to the third phase output line, the output stage comprises an output capacitor connected to a first output terminal and a second output terminal, a first switching leg connected to the first output terminal, the second output terminal, and the first secondary winding, a second switching leg connected to the first output terminal, the second output terminal, and the second secondary winding, and a third switching leg connected to the first output terminal, the second output terminal, and the third secondary winding, and the control engine is configured to control the first switching leg according to a first switching signal, control the second switching leg according to the first switching signal phase shifted by about 120°, and control the third switching leg according to the first switching signal phase shifted by about 240°.

According to some embodiments, the power converter comprises a first blocking capacitor connected between the first secondary winding and the first switching leg, a second blocking capacitor connected between the second secondary winding and the second switching leg, and a third blocking capacitor connected between the third secondary winding and the third switching leg.

According to some embodiments, the control engine is configured to control a phase shift between an input signal received at the three phase isolation transformer and an output signal generated by the three phase isolation transformer.

According to some embodiments, a power converter comprises a matrix front end comprising a first switching leg connected to a high side terminal, a low side terminal, and a first phase input line, a second switching leg connected to the high side terminal, the low side terminal, and a second phase input line, and a third switching leg connected to the high side terminal, the low side terminal, and a third phase input line, an integrated active filter connected to the high side terminal and the low side terminal, comprising an injection inductor selectively connected to one of the first phase input line, the second phase input line, or the third phase input line, and a fourth switching leg connected to the high side terminal, the low side terminal, and the injection inductor, an isolation circuit connected to the high side terminal and the low side terminal, an output stage connected to the isolation circuit, and a control engine configured to generate an output signal at the output stage by controlling switching of a first selected switching leg of the first switching leg, the second switching leg, or the third switching leg according to a first duty cycle, controlling switching of a second selected switching leg of the first switching leg, the second switching leg, or the third switching leg according to a complement of the first duty cycle, connecting one of the first phase input line, the second phase input line, or the third phase input line not associated with the first selected switching leg or the second selected switching leg to the injection inductor, and controlling switching of the fourth switching leg according to a second duty cycle.

According to some embodiments, the control engine is configured to select the first selected switching leg based on one of the first phase input line, the second phase input line, or the third phase input line having a highest voltage amplitude and select the second selected switching leg based on one of the first phase input line, the second phase input line, or the third phase input line having a lowest voltage amplitude.

According to some embodiments, the control engine is configured to connect one of the first phase input line, the second phase input line, or the third phase input line having a middle voltage amplitude between the highest voltage amplitude and the lowest voltage amplitude to the injection inductor.

According to some embodiments, the power converter comprises a first bidirectional switch connected between the first phase input line and the injection inductor, a second bidirectional switch connected between the second phase input line and the injection inductor, and a third bidirectional switch connected between the third phase input line and the injection inductor, wherein the control engine is configured to control the first bidirectional switch, the second bidirectional switch, and the third bidirectional switch to selectively connect one of the first phase input line, the second phase input line, or the third phase input line to the injection inductor.

According to some embodiments, the isolation circuit comprises a galvanic isolation transformer.

According to some embodiments, the isolation circuit comprises a blocking capacitor connected to the galvanic isolation transformer.

According to some embodiments, the isolation circuit comprises an inductor connected to the galvanic isolation transformer.

According to some embodiments, the output stage comprises an output capacitor connected to a first output terminal and a second output terminal, a fifth switching leg connected to the first output terminal, the second output terminal, and a first terminal of the galvanic isolation transformer, and a sixth switching leg connected to the first output terminal, the second output terminal, and a second terminal of the galvanic isolation transformer, wherein the control engine is configured to control the fifth switching leg according to a phase shifted version of the first duty cycle and control the sixth switching leg according to a complement of the phase shifted version of the first duty cycle.

According to some embodiments, a method comprises connecting a first switching leg to a high side terminal, a low side terminal, and a first phase input line, connecting a second switching leg to the high side terminal, the low side terminal, and a second phase input line, connecting a third switching leg to the high side terminal, the low side terminal, and a third phase input line, selectively connecting an injection inductor to one of the first phase input line, the second phase input line, or the third phase input line, connecting a fourth switching leg to the high side terminal, the low side terminal, and the injection inductor, connecting an isolation circuit to the high side terminal and the low side terminal, connecting an output stage to the isolation circuit, and generating an output signal at the output stage by controlling switching of a first selected switching leg of the first switching leg, the second switching leg, or the third switching leg according to a first duty cycle, controlling switching of a second selected switching leg of the first switching leg, the second switching leg, or the third switching leg according to a complement of the first duty cycle, connecting one of the first phase input line, the second phase input line, or the third phase input line not associated with the first selected switching leg or the second selected switching leg to the injection inductor, and controlling switching of the fourth switching leg according to a second duty cycle.

According to some embodiments, the method comprises selecting the first selected switching leg based on one of the first phase input line, the second phase input line, or the third phase input line having a highest voltage amplitude and selecting the second selected switching leg based on one of the first phase input line, the second phase input line, or the third phase input line having a lowest voltage amplitude.

According to some embodiments, the method comprises connecting one of the first phase input line, the second phase input line, or the third phase input line having a middle voltage amplitude between the highest voltage amplitude and the lowest voltage amplitude to the injection inductor.

According to some embodiments, the method comprises connecting a first bidirectional switch between the first phase input line and the injection inductor, connecting a second bidirectional switch between the second phase input line and the injection inductor, connecting a third bidirectional switch between the third phase input line and the injection inductor, and controlling at least one of the first bidirectional switch, the second bidirectional switch, or the third bidirectional switch to selectively connect one of the first phase input line, the second phase input line, or the third phase input line to the injection inductor.

According to some embodiments, the isolation circuit comprises a galvanic isolation transformer, and a blocking capacitor connected to the galvanic isolation transformer.

According to some embodiments, the isolation circuit comprises a galvanic isolation transformer, and connecting the output stage comprises connecting an output capacitor to a first output terminal and a second output terminal, connecting a fifth switching leg to the first output terminal, the second output terminal, and a first terminal of the galvanic isolation transformer, and connecting a sixth switching leg to the first output terminal, the second output terminal, and a second terminal of the galvanic isolation transformer, and the method comprises controlling the fifth switching leg according to a phase shifted version of the first duty cycle, and controlling the sixth switching leg according to an inverted version of the phase shifted version of the first duty cycle.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Any aspect or design described herein as an “example” is not necessarily to be construed as advantageous over other aspects or designs. Rather, use of the word “example” is intended to present one possible aspect and/or implementation that may pertain to the techniques presented herein. Such examples are not necessary for such techniques or intended to be limiting. Various embodiments of such techniques may include such an example, alone or in combination with other features, and/or may vary and/or omit the illustrated example.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first element and a second element generally correspond to element A and element B or two different or two identical elements or the same element.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A power converter, comprising:
a switching stage comprising:
a first switch block configured to connect a first phase input line to one of a first phase output line, a second phase output line, or a third phase output line;
a second switch block configured to connect a second phase input line to one of the first phase output line, the second phase output line, or the third phase output line; and
a third switch block configured to connect a third phase input line to one of the first phase output line, the second phase output line, or the third phase output line;
a three-phase isolation transformer comprising:
a first primary winding connected to the first phase output line;
a second primary winding connected to the second phase output line; and
a third primary winding connected to the third phase output line;
an output stage connected to the three-phase isolation transformer; and
a control engine configured to generate an output signal at the output stage by:
controlling switching of one of the first switch block, the second switch block, or the third switch block associated with one of the first phase input line, the second phase input line, or the third phase input line having a highest voltage amplitude.

2. The power converter of claim 1, wherein:
the switching stage comprises:
a first bidirectional switch connected to the first phase input line;
a second bidirectional switch connected to the second phase input line; and
a third bidirectional switch connected to the third phase input line, wherein:
the control engine is configured to control switching of the switching stage by controlling switching of the first bidirectional switch, the second bidirectional switch, and the third bidirectional switch.

3. The power converter of claim 1, comprising:
a first blocking capacitor connected between the first phase output line and the first primary winding;
a second blocking capacitor connected between the second phase output line and the second primary winding; and
a third blocking capacitor connected between the third phase output line and the third primary winding.

4. The power converter of claim 1, wherein:
the three phase isolation transformer comprises:
a first secondary winding connected to the first phase output line;
a second secondary winding connected to the second phase output line; and
a third secondary winding connected to the third phase output line;
the output stage comprises:
an output capacitor connected to a first output terminal and a second output terminal;
a first switching leg connected to the first output terminal, the second output terminal, and the first secondary winding;
a second switching leg connected to the first output terminal, the second output terminal, and the second secondary winding; and
a third switching leg connected to the first output terminal, the second output terminal, and the third secondary winding; and
the control engine is configured to:
control the first switching leg according to a first switching signal;
control the second switching leg according to the first switching signal phase shifted by about 120°; and
control the third switching leg according to the first switching signal phase shifted by about 240°.

5. The power converter of claim 4, comprising:
a first blocking capacitor connected between the first secondary winding and the first switching leg;
a second blocking capacitor connected between the second secondary winding and the second switching leg; and
a third blocking capacitor connected between the third secondary winding and the third switching leg.

6. The power converter of claim 1, wherein:
the control engine is configured to control a phase shift between an input signal received at the three phase isolation transformer and an output signal generated by the three phase isolation transformer.

7. A power converter, comprising:
a matrix front end comprising:
a first switching leg connected to a high side terminal, a low side terminal, and a first phase input line;
a second switching leg connected to the high side terminal, the low side terminal, and a second phase input line; and
a third switching leg connected to the high side terminal, the low side terminal, and a third phase input line;
an integrated active filter connected to the high side terminal and the low side terminal, comprising:
an injection inductor selectively connected to one of the first phase input line, the second phase input line, or the third phase input line; and
a fourth switching leg connected to the high side terminal, the low side terminal, and the injection inductor;
an isolation circuit connected to the high side terminal and the low side terminal;
an output stage connected to the isolation circuit; and
a control engine configured to generate an output signal at the output stage by:
controlling switching of a first selected switching leg of the first switching leg, the second switching leg, or the third switching leg according to a first duty cycle;
controlling switching of a second selected switching leg of the first switching leg, the second switching leg, or the third switching leg according to a complement of the first duty cycle;
connecting one of the first phase input line, the second phase input line, or the third phase input line not associated with the first selected switching leg or the second selected switching leg to the injection inductor; and
controlling switching of the fourth switching leg according to a second duty cycle.

8. The power converter of claim 7, wherein:
the control engine is configured to:
select the first selected switching leg based on one of the first phase input line, the second phase input line, or the third phase input line having a highest voltage amplitude; and
select the second selected switching leg based on one of the first phase input line, the second phase input line, or the third phase input line having a lowest voltage amplitude.

9. The power converter of claim 8, wherein:
the control engine is configured to
connect one of the first phase input line, the second phase input line, or the third phase input line having a middle voltage amplitude between the highest voltage amplitude and the lowest voltage amplitude to the injection inductor.

10. The power converter of claim 7, comprising:
a first bidirectional switch connected between the first phase input line and the injection inductor;
a second bidirectional switch connected between the second phase input line and the injection inductor; and
a third bidirectional switch connected between the third phase input line and the injection inductor, wherein:
the control engine is configured to:
control the first bidirectional switch, the second bidirectional switch, and the third bidirectional switch to selectively connect one of the first phase input line, the second phase input line, or the third phase input line to the injection inductor.

11. The power converter of claim 7, wherein:
the isolation circuit comprises a galvanic isolation transformer.

12. The power converter of claim 11, wherein:
the isolation circuit comprises:
a blocking capacitor connected to the galvanic isolation transformer.

13. The power converter of claim 11, wherein:
the isolation circuit comprises:
an inductor connected to the galvanic isolation transformer.

14. The power converter of claim 13, wherein:
the output stage comprises:
an output capacitor connected to a first output terminal and a second output terminal;
a fifth switching leg connected to the first output terminal, the second output terminal, and a first terminal of the galvanic isolation transformer; and
a sixth switching leg connected to the first output terminal, the second output terminal, and a second terminal of the galvanic isolation transformer, wherein:
the control engine is configured to:
control the fifth switching leg according to a phase shifted version of the first duty cycle; and
control the sixth switching leg according to a complement of the phase shifted version of the first duty cycle.

15. A method, comprising:
connecting a first switching leg to a high side terminal, a low side terminal, and a first phase input line;
connecting a second switching leg to the high side terminal, the low side terminal, and a second phase input line;
connecting a third switching leg to the high side terminal, the low side terminal, and a third phase input line;
selectively connecting an injection inductor to one of the first phase input line, the second phase input line, or the third phase input line;
connecting a fourth switching leg to the high side terminal, the low side terminal, and the injection inductor;
connecting an isolation circuit to the high side terminal and the low side terminal;
connecting an output stage to the isolation circuit; and
generating an output signal at the output stage by:
controlling switching of a first selected switching leg of the first switching leg, the second switching leg, or the third switching leg according to a first duty cycle;
controlling switching of a second selected switching leg of the first switching leg, the second switching leg, or the third switching leg according to a complement of the first duty cycle;
connecting one of the first phase input line, the second phase input line, or the third phase input line not associated with the first selected switching leg or the second selected switching leg to the injection inductor; and
controlling switching of the fourth switching leg according to a second duty cycle.

16. The method of claim 15, comprising:
selecting the first selected switching leg based on one of the first phase input line, the second phase input line, or the third phase input line having a highest voltage amplitude; and
selecting the second selected switching leg based on one of the first phase input line, the second phase input line, or the third phase input line having a lowest voltage amplitude.

17. The method of claim 16, comprising:
connecting one of the first phase input line, the second phase input line, or the third phase input line having a middle voltage amplitude between the highest voltage amplitude and the lowest voltage amplitude to the injection inductor.

18. The method of claim 15, comprising:
connecting a first bidirectional switch between the first phase input line and the injection inductor;
connecting a second bidirectional switch between the second phase input line and the injection inductor;
connecting a third bidirectional switch between the third phase input line and the injection inductor; and
controlling at least one of the first bidirectional switch, the second bidirectional switch, or the third bidirectional switch to selectively connect one of the first phase input line, the second phase input line, or the third phase input line to the injection inductor.

19. The method of claim 15, wherein: the isolation circuit comprises:
a galvanic isolation transformer; and
a blocking capacitor connected to the galvanic isolation transformer.

20. The method of claim 15, wherein:
the isolation circuit comprises a galvanic isolation transformer; and
connecting the output stage comprises:
connecting an output capacitor to a first output terminal and a second output terminal;
connecting a fifth switching leg to the first output terminal, the second output terminal, and a first terminal of the galvanic isolation transformer; and
connecting a sixth switching leg to the first output terminal, the second output terminal, and a second terminal of the galvanic isolation transformer; and
the method comprises:
controlling the fifth switching leg according to a phase shifted version of the first duty cycle; and
controlling the sixth switching leg according to an inverted version of the phase shifted version of the first duty cycle.
